(19) United States
(12) Patent Application Publication
(10) Pub. No.: US 2026/0075509 A1
(43) Pub. Date: Mar. 12, 2026

(54) WIRELESS LOCAL AREA NETWORK (WLAN) SELECTION POLICY

(71) Applicant: INTERDIGITAL PATENT HOLDINGS, INC., Wilmington, DE (US)

(72) Inventors: Michael Starsinic, Newtown, PA (US); Guanzhou Wang, Brossard (CA)

(73) Assignee: INTERDIGITAL PATENT HOLDINGS, INC., Wilmington, DE (US)

(21) Appl. No.: 19/104,838

(22) PCT Filed: Aug. 18, 2023
(86) PCT No.: PCT/US2023/030573

§ 371 Date: Feb. 19, 2025

Related U.S. Application Data
(60) Provisional application No. 63/399,394, filed on Aug. 19, 2022.

(51) Int. Cl. H04W 48/18; H04W 76/10; H04W 76/30

(52) U.S. Cl. CPC H04W 48/18; H04W 76/10; H04W 76/30

(57) ABSTRACT

A method performed by a wireless transmit/receive unit (WTRU) may comprise: receiving configuration information, one or more WLANSP rules, and one or more URSP rules; determining a first RSD of a URSP rule for traffic associated with a first application, wherein the configuration information indicates that the first RSD is associated with a first WLANSP rule ID; performing a first WLANSP rule evaluation procedure; determining that the first WLAN rule ID is associated with a first PDU session determining a second RSD of a URSP rule for traffic associated with a second application, wherein the configuration information indicates that the second RSD is associated with a second WLANSP rule ID; and performing a second WLANSP rule evaluation procedure.

### CROSS-REFERENCE TO RELATED APPLICATIONS

This application claims the benefit of U.S. Provisional Application No. 63/399,394, filed Aug. 19, 2022, the contents of which are incorporated herein by reference.

### BACKGROUND

A wireless transmit/receive unit (WTRU) may receive access network discovery and selection policies (ANDSP). The ANDSP may contain one or more wireless local area network (WLAN) selection policy (WLANSP) rules as defined in certain wireless standards. WLANSP rules are a set of rules that are used by a WTRU to select and reselect WLAN access networks to connect to. The rules may be provided to the WTRU with priority information. Each rule may be assigned a priority. The WTRU may evaluate the rules in priority order and selects an available WLAN access network that matches and/or fulfils the requirements of the highest priority rule. The rules may also contain information about when the rules should be considered valid (e.g., time and location validity conditions).

### SUMMARY

A method performed by a wireless transmit/receive unit (WTRU) may comprise: receiving configuration information, one or more wireless local area network (WLAN) selection policy (WLANSP) rules, and one or more user equipment (UE) route selection policy (URSP) rules; determining a first route selection descriptors (RSD) of a URSP rule for traffic associated with a first application, wherein the configuration information indicates that the first RSD is associated with a first WLANSP rule ID; performing a first WLANSP rule evaluation procedure based on a WLANSP rule that is associated with the first WLANSP rule ID in the first RSD; determining that the first WLAN rule ID is associated with a first PDU session; determining a second RSD of a URSP rule for traffic associated with a second application, wherein the configuration information indicates that the second RSD is associated with a second WLANSP rule ID; and performing a second WLANSP rule evaluation procedure based on WLANSP rules associated with the first WLANSP rule ID in the first RSD and the second WLANSP rule ID in the second RSD.

The method may further comprise, establishing the first PDU session in a WLAN access network that is associated with the first WLANSP rule ID and based on the second WLANSP rule evaluation procedure, determining to release the first PDU session. Based on the second WLANSP rule evaluation procedure, the WTRU may determine to release the first PDU session. Furthermore, the WTRU may determine, as part of the second WLANSP rule evaluation, to establish a second PDU session in a second WLAN access network, wherein the second WLAN network is identified by the second WLANSP rule ID.

The RSD may include the configuration information. The URSP rules may include the configuration information. The configuration information may be part of an information element that indicates an association between the one or more WLANSP rules and the one or more URSP rules. The configuration information may be part of an information element that indicates an association between the one or more WLANSP rules and the RSDs.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment; and

FIG. 2 is an flow chart illustrating an example procedure for a WTRU to maintain a “currently matching” list; and

FIG. 3 is an flow chart illustrating an example procedure performed by a WTRU.

### DETAILED DESCRIPTION

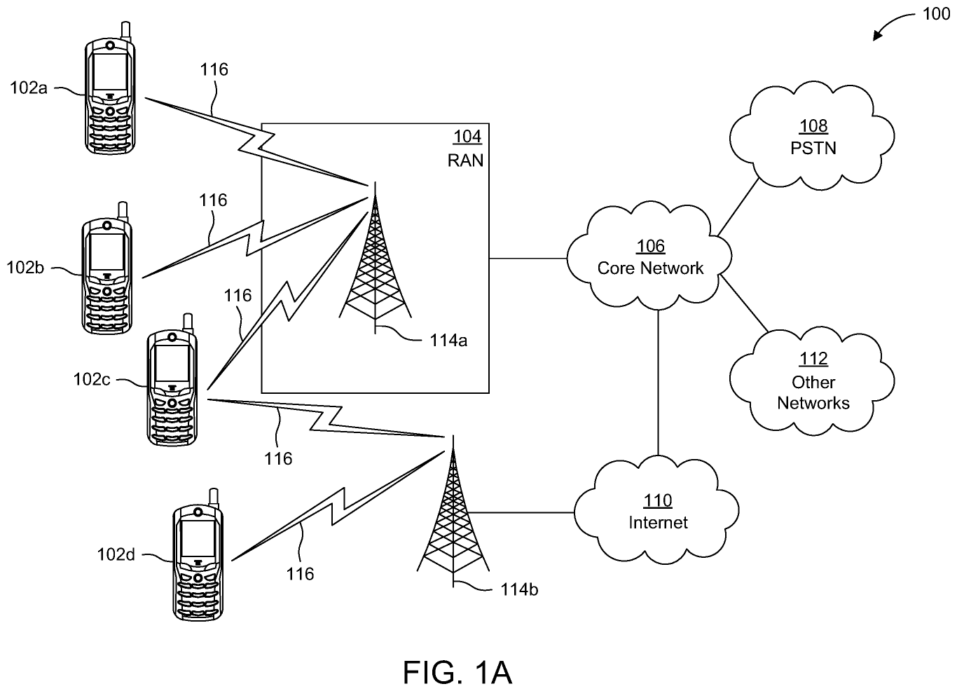

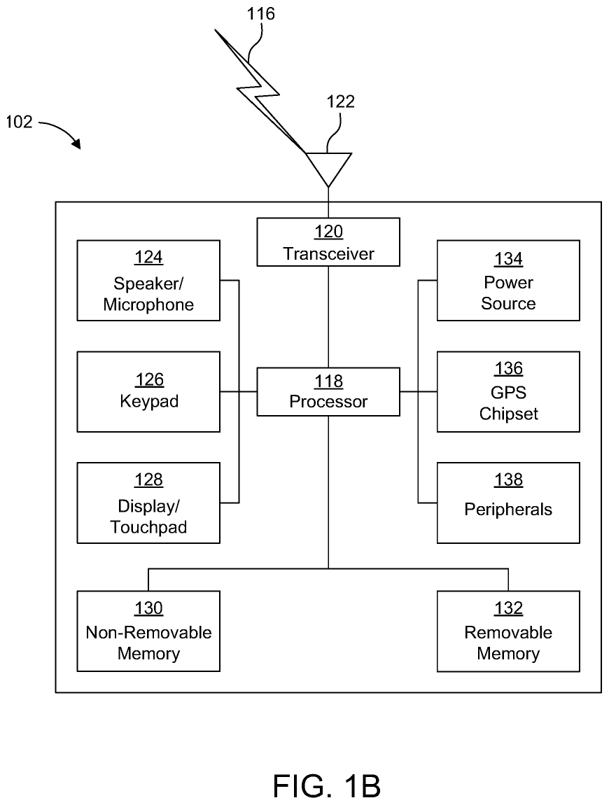

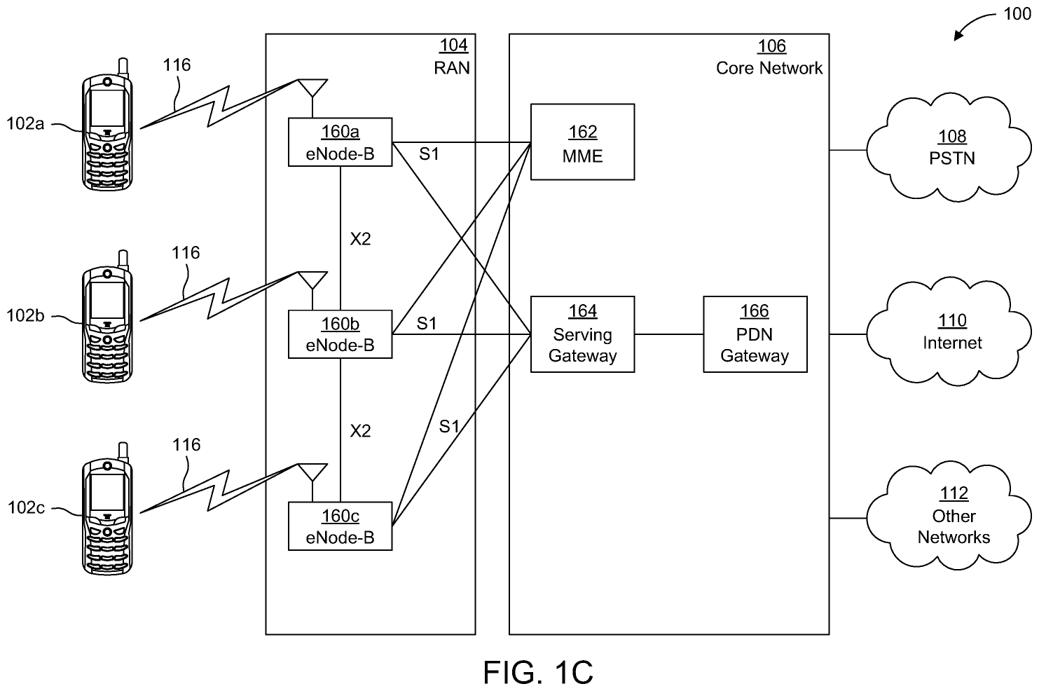

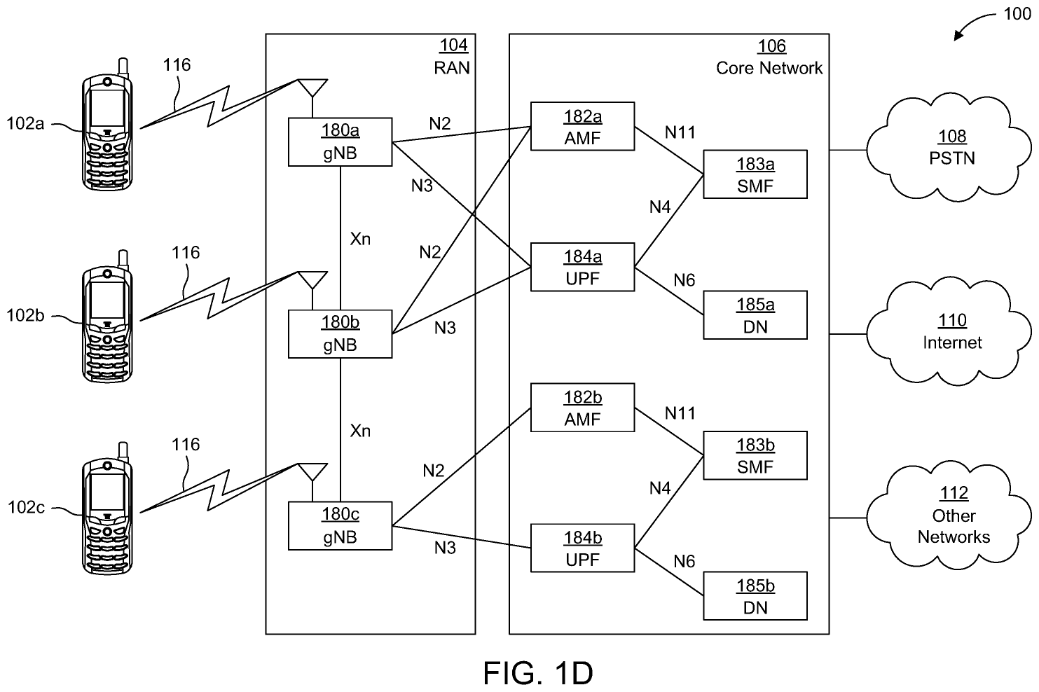

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VolP) services to one or more of the WTRUS 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QOS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms may be referred to:
ANDSP Access Network Discovery and Selection Policy
DNN Data Network Name
NAS Non-Access Stratum
PDU Protocol Data Unit
RSD Route Selection Descriptor
S-NSSAI Single Network Slice Selection Assistance Information
SSC Service and Service Continuity
UE User Equipment
URSP UE Route Selection Policy
WLAN Wireless Local Area Network
WLANSP WLAN Selection Policy
WTRU Wireless Transmit/Receive Unit

A wireless transmit/receive unit (WTRU) may receive access network discovery and selection policies (ANDSP). The ANDSP may contain one or more wireless local area network (WLAN) selection policy (WLANSP) rules as defined in certain wireless standards. WLANSP rules are a set of rules that are used by a WTRU to select and reselect WLAN access networks to connect to. The rules may be provided to the WTRU with priority information. Each rule may be assigned a priority. The WTRU may evaluate the rules in priority order and selects an available WLAN access network that matches and/or fulfils the requirements of the highest priority rule. The rules may also contain information about when the rules should be considered valid (e.g., time and location validity conditions).

The ANDSP may be received by the WTRU via NAS messaging. For example, the ANDSP may be received in policy sections that are received in the WTRU configuration update procedure, which may be defined in certain wireless standards.

User equipment (UE) route selection policy (URSP) rules may be defined as in wireless standards. When traffic is initiated by a WTRU application, the WTRU may use URSP rules to determine the desired characteristics for the PDU session that will carry the application traffic. An example of characteristics of a PDU session may be the DNN, S-NSSAI, and SSC mode that may be associated with the PDU session.

The URSP rule may be a policy that is used by the WTRU to determine how to route outgoing traffic. Traffic may be routed to an established PDU session, may be offloaded to non-3GPP access outside a PDU session, may be routed via a ProSe Layer-3 WTRU-to-network relay outside a PDU session, or may trigger the establishment of a new PDU session.

Each URSP rule may consist of two parts. The first part of a URSP rule may be a traffic descriptor that is used to determine when the rule is applicable. A URSP rule may be determined to be applicable when every component in the traffic descriptor matches the corresponding information from the application.

The second part of a URSP rule may be a list of route selection descriptors (RSDs). The list of RSDs may contain one or more RSDs. The RSDs may be listed in priority order and describe the characteristics of a PDU session that may be used to carry the uplink application data. Characteristics of a PDU session may include SSC mode, DNN, and S-NSSAI. The RSDs may alternatively include a non-seamless offload indication that indicates that the traffic may be sent via non-3GPP access (e.g., WiFi) and outside of any PDU session.

For every newly detected application, a WTRU may evaluate the URSP rules in the order of rule precedence and determines if the application matches the traffic descriptor of any URSP rule. When a URSP rule is determined to be applicable for a given application, the WTRU may select a RSD within this URSP rule in the order of the route selection descriptor precedence.

When a valid RSD is found, the WTRU may determine if there is an existing PDU session that matches all components in the selected RSD. When a matching PDU session exists, the WTRU may associate the application to the existing PDU session (i.e., the WTRU may route the traffic of the detected application on the already existing PDU session). If none of the existing PDU sessions match the RSD, the WTRU may try to establish a new PDU session using the values specified by the selected RSD.

If the RSD includes a non-seamless offload indication, the WTRU may attempt to use a WLAN access network to transmit the data outside of any PDU session. WLANSP rules may have been used to select the WLAN access network.

Once traffic from an application is associated with a PDU session, an event may cause the WTRU to re-evaluate the URSP rules and associate the traffic from the application with a different PDU session. Two examples of events that may trigger URSP re-evaluation may be: (1) an implementation dependent re-evaluation timer and (2) the WTRU establishing access to a Wi-Fi network that provides internet access without using the 5G System (i.e., non-seamless offload becomes possible).

A traffic descriptor may be an application descriptor, an IP descriptor, a domain descriptor, a non-IP descriptor, a DNN, or connection capabilities. An IP descriptor may be a destination IP 3 tuple(s) (i.e., an IP address or IPv6 network prefix, port number, protocol ID of the protocol above IP).

Some applications may have specific requirements of any access network that is used to send traffic from the application. An application may require that the access network that is used to send the application's data have certain characteristics.

When a WTRU performs WLAN access network selection, the WTRU may evaluate WLANSP rules without considering what applications may be running in the WTRU or will be running in the WTRU. Accordingly, the WTRU may sometimes select a WLAN access network that is not well suited to carry traffic that is generated by some of the applications that run on the WTRU.

Multiple applications may be running on the WTRU. When a new WTRU application starts and the WTRU detects newly generated application traffic, it may be preferable for the WTRU to consider the needs of all the running applications when evaluating WLANSP rules and selecting a WLAN access network.

The RSD of the URSP rules may be enhanced so that it can include a WLANSP rule ID. When the WTRU receives an RSD with a WLANSP rule ID and detects that the RSD is valid for a newly detected application, the WTRU may determine that the WLANSP rule that is identified in the RSD is well suited to carry traffic that is associated with the application.

The WTRU may then perform WLANSP rule evaluation of only the WLANSP rule that is included in RSD and exclude WLANSP rules that have been sent to the WTRU but are not part identified in the RSD. The WTRU may choose to do this so that it will select a WLAN access network that is best suited for the newly detected application layer traffic (i.e., this first application).

Later, a second application may begin to generate traffic. When this occurs, the WTRU may perform a new WLANSP evaluation operation and this evaluation operation may consider the preferences of both the first application and the second application.

For example, the WTRU may determine that a second RSD is valid for the second application and that the second RSD includes a second WLANSP ID. When this occurs, the WTRU may determine to perform a WLANSP rule evaluation procedure that only consider the first and second WLANSP rules. Thus, the evaluation operation will only consider the WLANSP rules that fulfil the needs of at least one application that is running on the WTRU.

Each time the WTRU determines that a RSD is valid for a running application's traffic and the RSD includes a WLANSP rule ID and a PDU session that matches the RSD is used to carry the application's traffic, the WTRU may add the WLANSP rule ID to a “currently matching” list. When the PDU session is released, the WTRU may remove the WLANSP rule ID if the WLANSP rule ID is not associated with any of the WTRU's other PDU sessions.

Each time the WTRU detects new application traffic and determines that a RSD is valid for the new application traffic and the RSD includes a WLANSP rule ID, the WTRU may determine to perform a WLANSP rule evaluation and only consider the WLANSP rules from the “currently matching” list and the rule that is identified in the RSD.

This approach allows the WTRU to only evaluate WLANSP rules that may be well suited for the currently running applications and the newly detected application. If the WTRU determines that it is able to route the newly detected application traffic over a WLAN access network, the WTRU may add the WLANSP rule ID from the RSD to the “currently matching” list. Once an RSD that includes a WLANSP rule ID is considered to be matching and a matching PDU session that meets the criteria of the WLANSP rule is used to send the application traffic, the WLANSP rule may be considered to be “currently matching” as long as the PDU session remains active via the same non-3GPP access.

By maintaining a “currently matching” list and only evaluating WLANSP rules that may be in the “currently matching” list and a WLANSP rule that matches a newly detected application, the WTRU may be more likely to select an WLAN access network that is well suited for the all the applications that may be currently running in the WTRU and can utilize WLAN access.

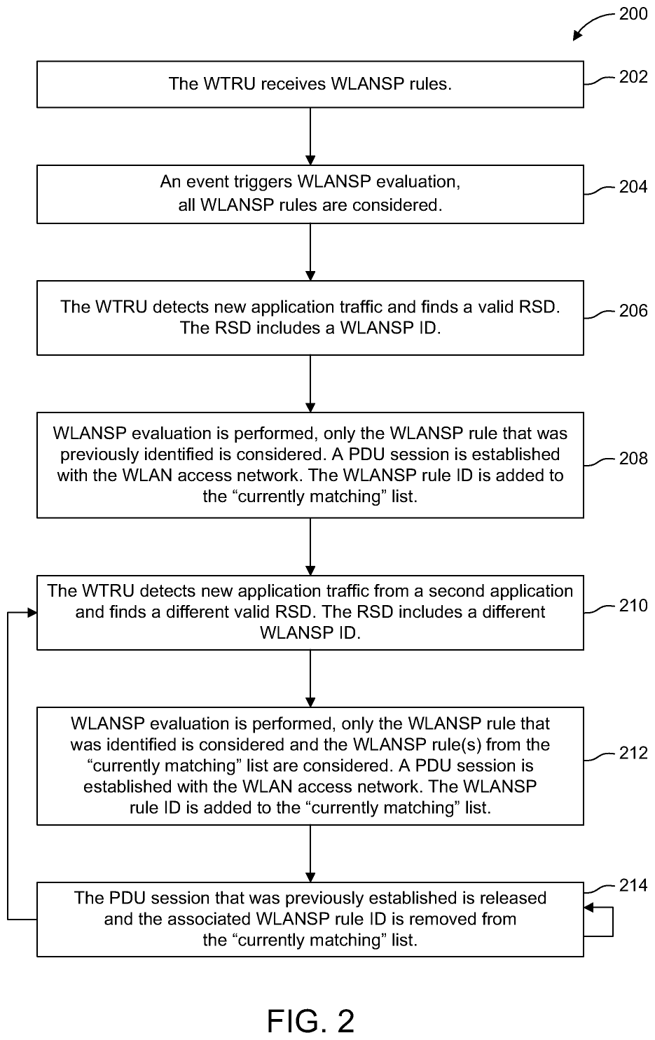

FIG. 2 is an example flowchart 200 for maintaining a “currently matching” list as described above. At 202, the WTRU may receive WLANSP rules. At 204, an event at the WTRU may cause the WTRU to perform a WLANSP rule evaluation and consider all of the WLANSP rules. An example event is that the WTRU is powered on. The result of WLANSP rule evaluation may be that the WTRU selects a WLAN access network and connects to it.

At 206, the WTRU may detect new application traffic and determine that an RSD is valid for the newly detected application traffic from the application. The RSD may include a WLANSP rule ID.

At 208, the presence of the WLANSP rule ID in the RSD may trigger the WTRU to perform a WLANSP rule evaluation and only consider the WLANSP rule that is identified by the WLANSP rule ID in the RSD. The WLANSP rule evaluation may result in the WTRU disconnecting from the WLAN access network that was selected at 204 and connect to a different WLAN access network which is better suited for the newly detected application traffic, and use the WLAN access network to establish a PDU session for the traffic from application. The WTRU may add the WLANSP rule ID to a “currently matching” list.

At 210, the WTRU may detect new application traffic form a second application and determine that a second RSD is valid for the newly detected application traffic from the second application. The RSD may include a second WLANSP rule ID.

At 212, the presence of the second WLANSP rule ID in the second RSD may trigger the WTRU to perform WLANSP rule evaluation and only consider the WLANSP Rules from the “currently matching” list and the second WLANSP rule that is identified by the second WLANSP rule ID in the RSD. The rules may be evaluated in priority order. The WLANSP Rule evaluation may result in the WTRU disconnecting from the WLAN access network that was selected at 208, connecting to a different WLAN access network which is better suited for the application traffic that was detected at both 206 and 210, and using the WLAN access network to establish a PDU session for the traffic from the second application

At 214, the PDU session that was established at 208 may be released. For example, the release may be triggered by termination of the application that was using the PDU session. Release of the PDU session may cause the WTRU to remove the associated WLANSP ID from the currently matching list. The process may return to 210 each time new application traffic is detected or 214 may repeat each time a PDU session is released.

The WLANSP rule ID may be part of an RSD. However, it may be encoded in different information elements. For example, the network may alternatively send the WTRU an information element that indicates which WLANSP rule Id(s) may be associated with each URSP rule or each RSD. The benefit of encoding the information in a separate information element in this manner is that a non-supporting WTRU may ignore the information element and still understand the URSP rules and RSDs that may be associated with WLANSP rule ID(s). Such a WTRU may not benefit from knowing which WLANSP rules may be associated with each application, but backwards compatibility may be maintained in this manner.

Described above is how a WLAN access network is used to establish a PDU session. Alternatively, the traffic may be carried outside of a PDU session over the WLAN access network (i.e., non-seamless offloading may be used). When this approach is taken, the WLANSP rule ID may be added to the “currently matching” list when the access network is used by an application and removed from the “currently matching” list when the access network is no longer used by the application.

In an example embodiment, the WTRU may: (1) receive one or more WLANSP rules, each of the one or more WLANSP rules is identified with a WLANSP rule id and associated with a priority; (2) receive information that indicates that a first RSD is associated a first WLANSP rule; (3) receive information that indicates that a second RSD is associated a second WLANSP rule; (4) determine to use a first PDU session that matches the first RSD and adding the first WLANSP rule ID of the first WLANSP rule to a currently matching list; and (5) determine that the second RSD is valid for a newly detected application. Based on determining that the second RSD is valid for a newly detected application, the WTRU may determine to evaluate WLANSP rules in priority order, wherein the evaluation operation is performed on the second WLANSP rule and the WLANSP rules from the currently matching list and wherein the evaluation operation excludes at least one WLANSP rule from the evaluation procedure; wherein the at least one WLANSP rule is excluded because it is not in the currently matching list and is not the second WLANSP rule.

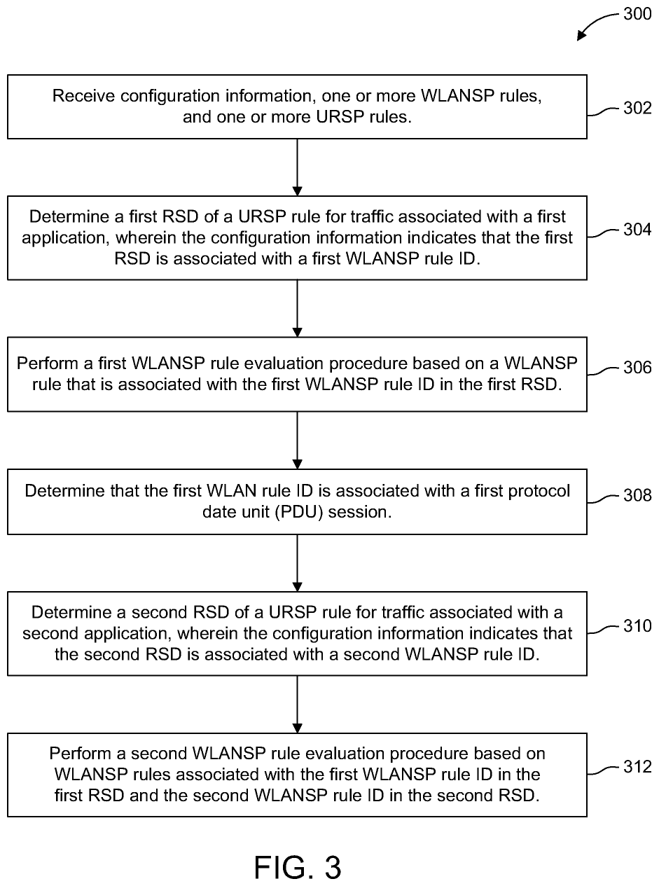

FIG. 3 is a flowchart illustrating an example procedure performed by a WTRU.

At 302, the WTRU may receive configuration information, WLANSP rules, and URSP rules.

At 304, the WTRU may determine a first RSD of a URSP rule for traffic associated with a first application, wherein the configuration information indicates that the first RSD is associated with a first WLANSP rule ID.

At 306, the WTRU may perform a first WLANSP rule evaluation procedure based on the WLANSP rule that is associated with the first WLANSP rule ID in the first RSD.

At 308, the WTRU may determine that the first WLAN rule ID is associated with a first PDU session.

At 310, the WTRU may determine a second RSD of a URSP rule for traffic associated with a second application, wherein the configuration information indicates that the second RSD is associated with a second WLANSP rule ID.

At 312, the WTRU may perform a second WLANSP rule evaluation procedure based on WLANSP rules associated with the first WLANSP rule ID in the first RSD and the second WLANSP rule ID in the second RSD.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

1. A method performed by a wireless transmit/receive unit (WTRU), the method comprising:
receiving configuration information and one or more route selection policy (RSP) rules;
determining a first route selection descriptor (RSD) of a first RSP rule for traffic associated with a first application, wherein the configuration information indicates that the first RSD indicates a first WLANSP rule identification (ID);
performing a first wireless local area network (WLAN) selection policy (WLANSP) rule evaluation procedure based on a first WLANSP rule that is associated with the first WLANSP rule ID in the first RSD;
determining a second RSD of a second RSP rule for traffic associated with a second application, wherein the configuration information indicates that the second RSD indicates a second WLANSP rule ID; and
performing a second WLANSP rule evaluation procedure based on (a) the first WLANSP rule associated with the first WLANSP rule ID in the first RSD and (b) a second WLANSP rule associated with the second WLANSP rule ID in the second RSD.

2. The method of claim 1, further comprising:
determining that the first WLAN rule ID is associated with a first protocol data unit (PDU) session; and
establishing the first PDU session in a WLAN access network that is associated with the first WLANSP rule ID.

3. The method of claim 2, further comprising:
based on the second WLANSP rule evaluation procedure, releasing the first PDU session.

4. The method of claim 3, further comprising:
establishing, as part of the second WLANSP rule evaluation procedure, a second PDU session in a second WLAN access network, wherein the second WLAN network is identified by the second WLANSP rule ID.

5. The method of claim 1, wherein at least one of the first RSD or the second RSD includes the configuration information.

6. The method of claim 1, wherein the RSP rules include the configuration information.

7. The method of claim 1, wherein the configuration information is part of an information element that indicates an association between the first WLANSP rule and the second WLANSP rule and the one or more RSP rules.

8. The method of claim 1, wherein the configuration information is part of an information element that indicates an association between the first WLANSP rule and the second WLANSP rule and the first RSD and the second RSD.

9. A wireless transmit/receive unit (WTRU) comprising:
a transceiver; and
a processor;
wherein the transceiver and processor are configured to:
receive configuration information and one or more route selection policy (RSP) rules;
determine a first route selection descriptor (RSD) of a first RSP rule for traffic associated with a first application, wherein the configuration information indicates that the first RSD indicates a first WLANSP rule identification (ID);
perform a first wireless local area network (WLAN) selection policy (WLANSP) rule evaluation procedure based on a first WLANSP rule that is associated with the first WLANSP rule ID in the first RSD;
determine a second RSD of a second RSP rule for traffic associated with a second application, wherein the configuration information indicates that the second RSD indicates a second WLANSP rule ID; and
perform a second WLANSP rule evaluation procedure based on (a) the first WLANSP rule associated with the first WLANSP rule ID in the first RSD and (b) a second WLANSP rule associated with the second WLANSP rule ID in the second RSD.

10. The WTRU of claim 9, wherein the processor is further configured to:
determine that the first WLANSP rule ID is associated with a first protocol data unit (PDU) session; and
establish the first PDU session in a WLAN access network that is associated with the first WLANSP rule ID.

11. The WTRU of claim 10, wherein the processor is further configured to:
based on the second WLANSP rule evaluation procedure, release the first PDU session.

12. The WTRU of claim 11, wherein the processor is further configured to:
establish, as part of the second WLANSP rule evaluation procedure, a second PDU session in a second WLAN access network, wherein the second WLAN network is identified by the second WLANSP rule ID.

13. The WTRU of claim 9, wherein at least one of the first RSD or the second RSD includes the configuration information.

14. The WTRU of claim 9, wherein the RSP rules include the configuration information.

15. The WTRU of claim 9, wherein the configuration information is part of an information element that indicates an association between the first WLANSP rule and the second WLANSP rule and the one or more RSP rules.

16. The WTRU of claim 9, wherein the configuration information is part of an information element that indicates an association between the first WLANSP rule and the second WLANSP rule and the first RSD and the second RSD.
